(19) United States
(12) Patent Application Publication
(10) Pub. No.: US 2024/0410452 A1
(43) Pub. Date: Dec. 12, 2024

(54) INTEGRATED POWER SYSTEM BASED ON TOOTHED BELT STRUCTURE AND EXOSKELETON ROBOT

(71) Applicant: ULSROBOTICS CO., LTD., Shanghai (CN)

(72) Inventor: Zhenhua XU, Shanghai (CN)

(21) Appl. No.: 18/663,220

(22) Filed: May 14, 2024

Related U.S. Application Data
(63) Continuation of application No. PCT/CN2023/121637, filed on Sep. 26, 2023.

(30) Foreign Application Priority Data
Jun. 6, 2023 (CN) 202310664923.6

(51) Int. Cl. F16H 19/08; B25J 9/00

(52) U.S. Cl. CPC F16H 19/08; B25J 9/0006; F16H 2019/085

(57) ABSTRACT

An integrated power system based on toothed belt structure includes a base plate, and a drive motor, a reduction gear mechanism, a synchronous belt mechanism for power transmission and a torque output mechanism sequentially arranged on the base plate, the reduction gear mechanism includes a first gear set and a second gear set to reduce an output rotation speed of the drive motor respectively located on two sides of the base plate. An exoskeleton robot includes the above integrated power system, a back structure of main body, a leg structure of femur portion hinged with a waist portion of the back structure of main body, and a leg structure of fibula portion coupled with a base body fastener, the leg structure of fibula portion is coupled with the actuator.

### CROSS-REFERENCE TO RELATED APPLICATION

This application is a continuation of PCT application serial no. PCT/CN2023/121637, filed on Sep. 26, 2023, which claims the priority and benefit of Chinese patent application serial no. 202310664923.6, filed on Jun. 6, 2023. The entireties of PCT application serial no. PCT/CN2023/121637 and Chinese patent application serial no. 202310664923.6 are hereby incorporated by reference herein and made a part of this specification.

### TECHNICAL FIELD

The present disclosure relates to the technical field of exoskeletons, and more particularly, to an integrated power system based on toothed belt structure and an exoskeleton robot.

### BACKGROUND ART

Since the exoskeleton was developed in the 1960s, there has been a shift from the military field to the civilian market, mostly with medical and industrial production as the main purpose. As an auxiliary tool to help workers load to carry out manufacturing and handling tasks, the exoskeletons are currently developed in the directions of stronger load-bearing capacity, greater control and flexibility. A wearable lower extremity exoskeleton system provides the wearer with additional power or ability, so as to enhance body function and perform certain functions and tasks under the control of the operator.

In the existing technique, drive devices for lower extremity exoskeleton systems are commonly installed at various joints of the lower extremity, such as the left and right hip joints and knee joints. A commonly used drive device is a power system of servo motor, and the power system of servo motor is mostly in the form by which gears are directly connected or coaxially arranged for deceleration, such a power system as a whole is larger and heavier, the application thereof is not flexible and convenient, which results in a large size and heavy weight of the whole machine.

### SUMMARY

In order to reduce the size and weight of the drive devices used in lower extremity exoskeleton systems, the present disclosure provides an integrated power system based on toothed belt structure and an exoskeleton robot.

In the first aspect, the present disclosure provides an integrated power system based on toothed belt structure, including a base plate, and a drive motor, a reduction gear mechanism, a synchronous belt mechanism for power transmission and a torque output mechanism sequentially arranged on the base plate for performing power transmission, and in particular, the reduction gear mechanism includes a first gear set and a second gear set configured to reduce an output rotation speed of the drive motor, the first gear set and the second gear set are respectively located on two sides of the base plate, the drive motor and the second gear set are located on a first side of the two sides of the base plate, the synchronous belt mechanism for power transmission and the first gear set are located on a second side of the two sides of the base plate, and the torque output mechanism is located on the first side of the two sides of the base plate.

By adopting the above-mentioned technical solution, the first gear set and the second gear set are respectively mounted on the two sides of the base plate, while the synchronous belt mechanism for power transmission and the torque output mechanism are respectively mounted on the two sides of the base plate, which can reduce the volume of the power system to a large extent. And a stable mute power output with high impact resistance and high precision can be achieved through the layout of the reduction gear mechanism and the synchronous belt power transmission. Furthermore, with the first gear set and the second gear set, a double deceleration effect can be achieved.

Optionally, the first gear set includes a power gear and a first reduction gear meshed with each other, the power gear is fixedly mounted on an output shaft of the drive motor, the first reduction gear is located on the second side of the two sides of the base plate and rotatably mounted on the base plate, and a diameter of the first reduction gear is greater than a diameter of the power gear.

By adopting the above-mentioned technical solution, the drive motor drives the power gear to rotate, and further drives the first reduction gear to rotate, so as to realize the first-stage reduction.

Optionally, a holding plate is mounted on the second side of the two sides of the base plate, the holding plate is in a shape of a plate with a plurality of hollows, and a gear shaft on the first reduction gear is rotatably mounted on the base plate at a first end of the gear shaft and rotatably mounted on the holding plate at a second end of the gear shaft.

By adopting the above-mentioned technical solution, the first reduction gear is mounted by means of the holding plate, so that the rotation of the first reduction gear is more stable and a better transmission effect is maintained.

Optionally, the second gear set includes an intermediate gear and a second reduction gear meshed with each other, the intermediate gear and the second reduction gear both are rotatably mounted on the base plate, the intermediate gear and the first reduction gear are coaxially arranged and rotate synchronously, a diameter of the second reduction gear is greater than a diameter of the intermediate gear, and the diameter of the intermediate gear is smaller than the diameter of the first reduction gear.

By adopting the above-mentioned technical solution, after the first-stage reduction is performed by the first reduction gear, the second-stage reduction is performed by the intermediate gear and the second reduction gear, so as to achieve the double deceleration effect of the integrated power system in cooperation with the first gear set.

Optionally, the synchronous belt mechanism for power transmission includes a synchronous belt, and a first pulley and a second pulley rotatably mounted on the base plate, the first pulley and the second pulley are arranged on the second side of the two sides of the base plate, the synchronous belt is wound around the first pulley and the second pulley, the first pulley is coaxially arranged with a second reduction gear in a second gear set, and a diameter of the second pulley is greater than a diameter of the first pulley.

By adopting the above-mentioned technical solution, after the second-stage reduction is performed via the second reduction gear, the third-stage reduction can be performed by means of the synchronous belt mechanism for power transmission.

Optionally, a first mount and a second mount are respectively provided on the second side of the two sides of the base plate, a first end of a rotation shaft where the first pulley is located is rotatably mounted on the base plate while a second end of the rotation shaft where the first pulley is located is rotatably mounted on the first mount, and a first end of a rotation shaft where the second pulley is located is rotatably mounted on the base plate while a second end of the rotation shaft where the second pulley is located is rotatably mounted on the second mount.

By adopting the above-mentioned technical solution, the first pulley and the second pulley are respectively mounted by means of the first mount and the second mount, so that the both are more stable during moving.

Optionally, the torque output mechanism includes an output shaft and an output disc, the output shaft of the torque output mechanism is located on the first side of the two sides of the base plate, coaxially arranged with the second pulley and fixed with the rotation shaft where the second pulley is located, and the output disc is fixed at an end of the output shaft of the torque output mechanism and located on the first side of the two sides of the base plate.

By adopting the above-mentioned technical solution, the output disc, as a power output portion, is mounted on the first side of the base plate, so that the integrated power system is more compact in structure.

Optionally, an actuator is fixedly connected to the output disc, a fixing disc is provided on the first side of the two sides of the base plate, the fixing disc is coaxially arranged with the output disc, and a base body fastener is fixedly mounted on a side of the fixing disc away from the base plate.

By adopting the above-mentioned technical solution, the actuator, as a final power actuation element in the integrated power system, is configured to be directly connected to a structure to be driven thereby. The base body fastener is configured for mounting and fixing the integrated power system, and is directly connected to a fixing mechanism corresponding to a driving mechanism connected to the actuator. When the actuator rotates, the driving mechanism connected thereto can rotate relative to the fixing mechanism, so as to achieve the power output of the integrated power system.

Optionally, a limit disc is fixedly arranged on a side of the base body fastener away from the fixing disc, the limit disc is coaxially arranged with the fixing disc, a first circumferential limit block is mounted on a side of the limit disc away from the base body fastener, a second circumferential limit block is mounted on a side of the actuator close to the output disc, and the first circumferential limit block and the second circumferential limit block partially overlap each other in an axial direction of the output disc.

By adopting the above-mentioned technical solution, when the drive motor drives the actuator to rotate, the rotation angle of the actuator can be limited due to the cooperation of the first circumferential limit block and the second circumferential limit block.

In the second aspect, the present disclosure provides an exoskeleton robot, including the above-mentioned integrated power system based on toothed belt structure, further including a back structure of main body, a leg structure of femur portion hinged with a waist portion of the back structure of main body, and a leg structure of fibula portion coupled with a base body fastener, and the leg structure of fibula portion is coupled with the actuator.

By adopting the above-mentioned technical solution, when the exoskeleton robot is worn, the leg structure of fibula portion, driven by the integrated power system, can rotate relative to the leg structure of femur portion when people walks, so as to achieve the effect of assisting people to walk, and by means of modularization and combination design with the main housing, the problem that the overall mechanism of the existing exoskeleton power system is large and heavy, and the application is not flexible and convenient can be effectively solved, while realizing a stable mute power-assisted output of exoskeleton with high impact resistance and high-precision.

In summary, the present disclosure includes at least one of the following beneficial technical effects:
1. When the integrated power system is in a special operation, the power gear is driven to rotate by the drive motor, and the first-stage reduction is performed via the first gear set, then the second-stage reduction is performed after the power is transmitted to the second gear set, and then the third-stage reduction is performed via the synchronous belt mechanism for power transmission, and finally the power is output by the power output mechanism; furthermore, with the first gear set and the second gear set, a double deceleration effect can be achieved.
2. The first gear set and the second gear set are respectively mounted on the two sides of the base plate, while the synchronous belt mechanism for power transmission and the torque output mechanism are respectively mounted on the two sides of the base plate, which can reduce the volume of the power system to a large extent. And a stable mute power output with high impact resistance and high precision can be achieved through the layout of the reduction gear mechanism and the synchronous belt power transmission.
3. The actuator, as a final power actuation element in the integrated power system, is configured to be directly connected to a structure to be driven thereby. The base body fastener is configured for mounting and fixing the integrated power system, and is directly connected to a fixing mechanism corresponding to a driving mechanism connected to the actuator. When the actuator rotates, the driving mechanism connected thereto can rotate relative to the fixing mechanism, so as to achieve the power output of the integrated power system.

### BRIEF DESCRIPTION OF THE DRAWINGS

FIG. 1 is a schematic structural diagram showing mounting positions of a drive motor, the second gear set, and a torque output mechanism according to an embodiment of the present disclosure;

FIG. 2 is a schematic structural diagram showing mounting positions of the first gear set and a synchronous belt mechanism for power transmission according to an embodiment of the present disclosure;

FIG. 3 is a schematic structural diagram showing mounting positions of a holding plate, a first mount and a second mount according to an embodiment of the present disclosure;

FIG. 4 is a schematic structural diagram showing mounting positions of a mounting rack, a base body fastener, and an actuator according to an embodiment of the present disclosure;

FIG. 5 is a schematic structural diagram showing mounting positions of a limit disc, the first circumferential limit block and the second circumferential limit block according to an embodiment of the present disclosure;

FIG. 6 is a schematic diagram showing an overall structure of the first protective housing and the second protective housing after being mounted on the base plate according to an embodiment of the present disclosure; and

FIG. 7 is a schematic diagram showing an overall structure of a lower extremity exoskeleton robot according to an embodiment of the present disclosure.

### DETAILED DESCRIPTION

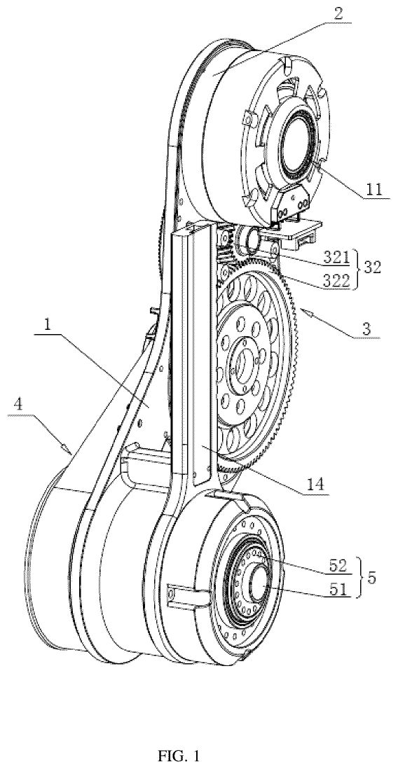

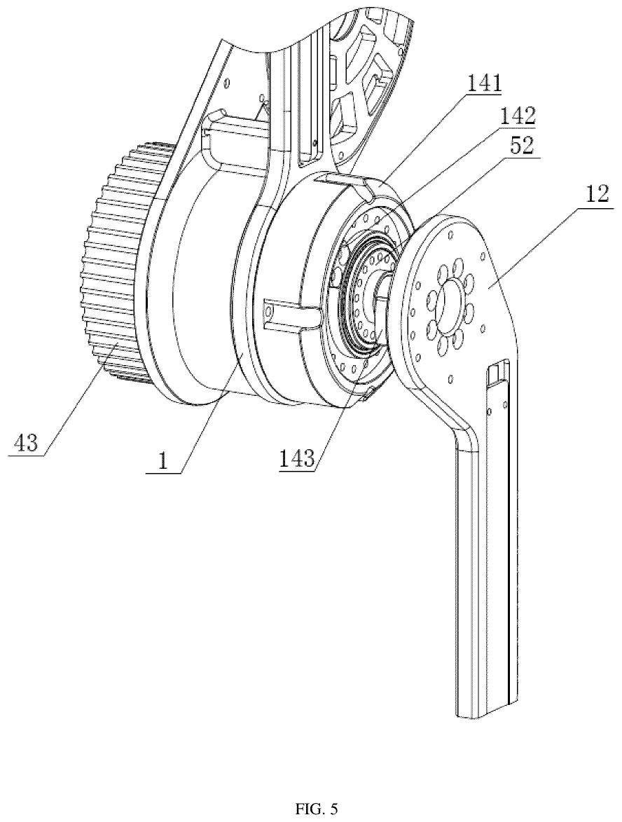

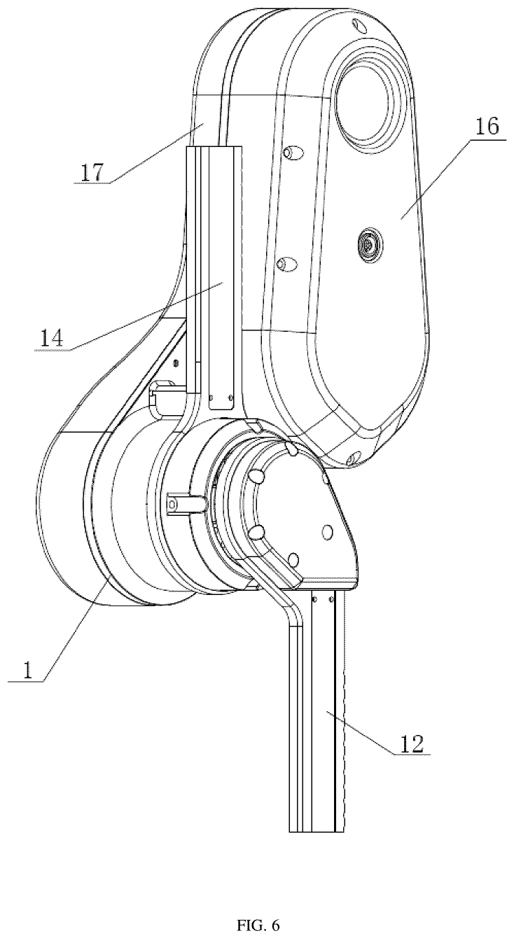

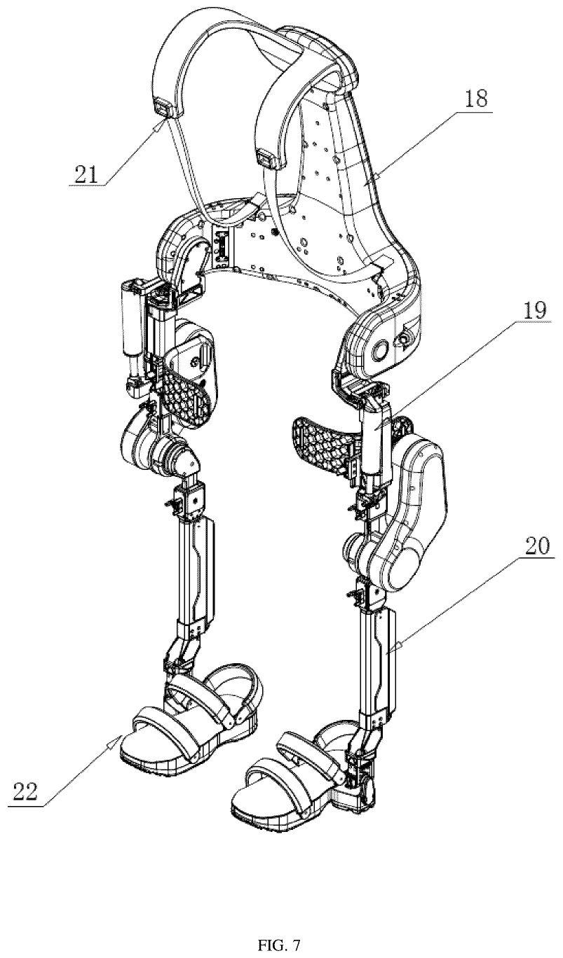

The present disclosure is further illustrated in combination with FIGS. 1-7.

### Embodiments

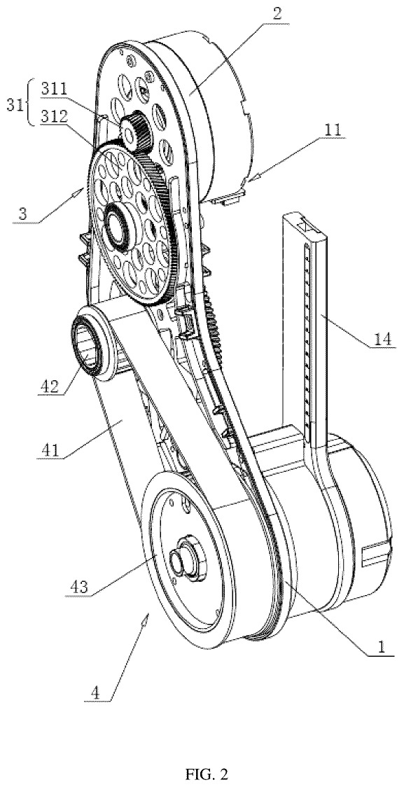

An integrated power system based on toothed belt structure, with reference to FIGS. 1 and 2, includes a base plate 1, and a drive motor 2, a reduction gear mechanism 3, a synchronous belt mechanism for power transmission 4 and a torque output mechanism 5 which are sequentially arranged on the base plate 1, in particular, the drive motor 2, as a power source, is configured to provide power to the reduction gear mechanism 3, which, after deceleration in the reduction gear mechanism 3, is then transmitted to the synchronous belt mechanism for power transmission 4, and finally is output by the torque output mechanism 5, the power output therefrom can be applied to a leg structure of fibula portion in a lower extremity exoskeleton system, so as to drive it to rotate around the knee joint, so as to complete the walking action.

Specifically, the reduction gear mechanism 3 includes the first gear set 31 and the second gear set 32 cooperating with each other. The first gear set 31 is connected to an output shaft of the drive motor 2, the second gear set 32 is connected to the synchronous belt mechanism for power transmission 4, and the first gear set 31 and the second gear set 32 are respectively located on two sides of the base plate 1. That is, the power output from the drive motor 2 is first transmitted to the first gear set 31, then transmitted to the second gear set 32, and then received by the synchronous belt mechanism for power transmission 4 and transmitted to the torque output mechanism 5.

Further, the first gear set 31 includes a power gear 311 and the first reduction gear 312 meshed with each other. The power gear 311 is coupled with the output shaft of the drive motor 2 via a pin and rotates along with the output shaft of the drive motor 2, the first reduction gear 312 is rotatably mounted on the base plate 1, in particular, the power gear 311 and the first reduction gear 312 are both located on a same side of the base plate 1, and a diameter of the first reduction gear 312 is greater than a diameter of the power gear 311, to achieve a deceleration effect. In the present embodiment, the power gear 311 and the first reduction gear 312 each are configured as a helical gear.

The second gear set 32 includes an intermediate gear 321 and a second reduction gear 322 meshed with each other. The intermediate gear 321 and the second reduction gear 322 are located on a side of the base plate 1 remote from the first gear set 31 and are rotatably mounted on the base plate 1. A diameter of the second reduction gear 322 is greater than a diameter of the intermediate gear 321, and the diameter of the intermediate gear 321 is less than the diameter of the first reduction gear 312. The intermediate gear 321 is coaxially arranged with the first reduction gear 312 in the first gear set 31, and the both rotate synchronously, namely, rotation speeds of the first reduction gear 312 and the intermediate gear 321 are equal. Also, in the present embodiment, the intermediate gear 321 and the second reduction gear 322 each are configured as a helical gear.

The power gear 311 cooperates with the first reduction gear 312 and the intermediate gear 321 cooperates with the second reduction gear 322, to form a double reduction system, thereby achieving a relatively stable deceleration effect. The helical gear used therein has the advantages of small volume, light weight, large torque transmission and fine classification of transmission ratio. By the layout in which two gear sets are respectively placed on the two sides of the base plate 1, the overall volume of the integrated power system is greatly reduced while reducing the weight of the integrated power system.

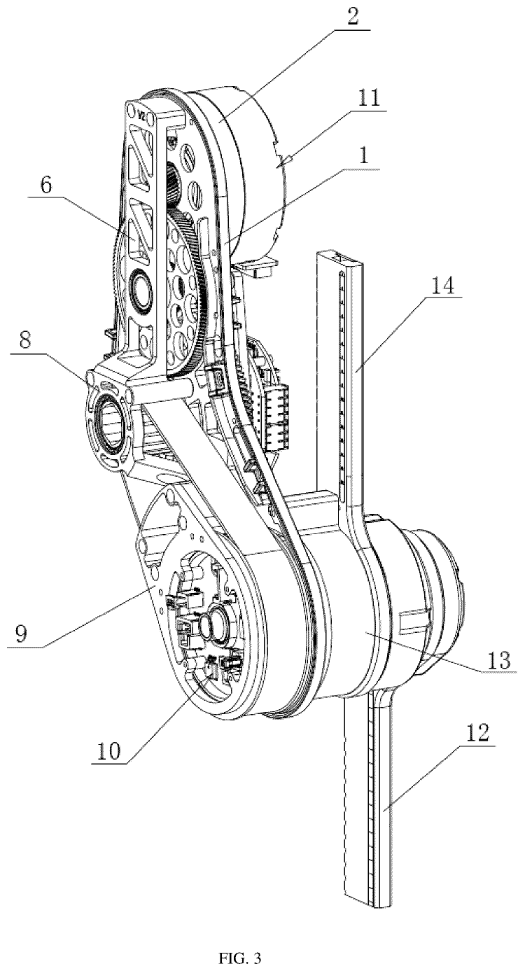

Referring to FIGS. 1 and 3, in order to improve the installation stability of gears, a holding plate 6 is mounted on the side of the base plate 1 close to the first gear set 31, the holding plate 6 is shaped as a cuboid plate with a plurality of hollows, and the holding plate 6 and the base plate 1 can be locked and fixed via screws. In the present embodiment, the holding plate 6 is arranged in parallel with the base plate 1. When mounting the first reduction gear 312, a gear shaft of the first reduction gear 312 is rotatably mounted on the base plate 1 with one end and is rotatably mounted on the holding plate 6 with the other end, to ensure the stable rotation of the first reduction gear 312. In the present embodiment, the gear shaft of the first reduction gear 312 is a sleeve formed on a gear hub of the first reduction gear 312. A gear shaft of the intermediate gear 321 is fixedly connected to the gear shaft of the first reduction gear 312, to ensure the synchronous rotation of the both. Also, in the present embodiment, the gear shaft of the intermediate gear 321 is configured as a sleeve formed on a gear hub of the intermediate gear 321, and the gear shaft of the intermediate gear 321 may be fastened with the gear shaft of the first reduction gear 312 via bolts, to ensure the synchronous rotation of the two.

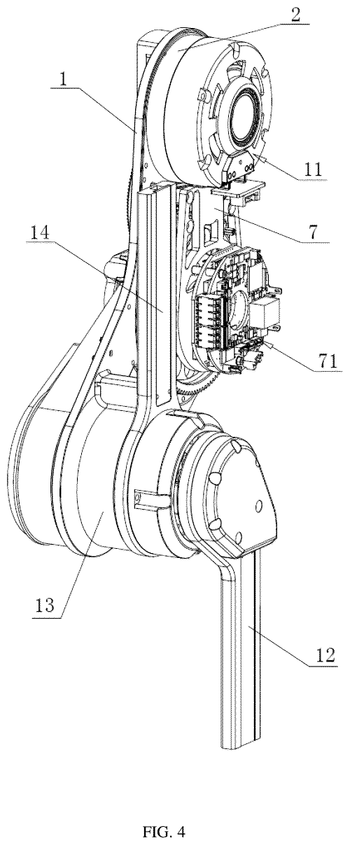

Referring to FIGS. 1 and 4, a side of the base plate 1 close to the second gear set 32 is provided with a mounting rack 7, the mounting rack 7 and the base plate 1 can be locked and fixed by means of screws, the mounting rack 7 is configured for mounting a PCB board 71, and the PCB board 71 is mainly integrated with a control system of the drive motor 2 for receiving output signals of the drive motor 2 and the torque output mechanism 5 and adjusting the movement state of the drive motor 2. The mounting rack 7 as a whole is shaped as a disc and is coaxially arranged with the second reduction gear 322 in the second gear set 32, to reduce the space occupied by the PCB board 71, thereby making the structure more compact. Meanwhile, a data transmission interface is further defined on a housing of the base plate 1.

Referring to FIGS. 2 and 3, specifically, the synchronous belt mechanism for power transmission 4 includes a synchronous belt 41, the first pulley 42 and the second pulley 43 rotatably mounted on the base plate 1, and in particular, the first pulley 42 and the second pulley 43 are provided on the side of the base plate 1 close to the first gear set 31, and the synchronous belt 41 is wound around the first pulley 42 and the second pulley 43 to achieve the synchronous rotation of the both. An inner side of the synchronous belt 41 is provided with teeth configured to be engaged with the teeth on the first pulley 42 and the second pulley 43, to ensure a stable transmission ratio between the first pulley 42 and the second pulley 43.

Further, a diameter of the second pulley 43 is greater than a diameter of the first pulley 42, and the first pulley 42 is coaxially arranged with the second reduction gear 322 in the second gear set 32 and the both rotate synchronously, namely, the second reduction gear 322 and the first pulley 42 rotate at the same speed. That is, with the synchronous belt mechanism for power transmission 4, a deceleration effect during the power transmission can also be achieved. At the same time, the transmission with toothed belt also has the characteristics of smooth transmission, simple structure, low cost, easy maintenance and slip during overload.

In order to facilitate the mounting of the first pulley 42 and the second pulley 43, a side of the base plate 1 close to the synchronous belt mechanism for power transmission 4 is respectively provided with the first mount 8 for mounting the first pulley 42 in cooperation with the base plate 1 and the second mount 9 for mounting the second pulley 43 in cooperation with the base plate 1.

Specifically, the first mount 8 may be locked and fixed on the base plate 1 by means of screws, and one end of a rotation shaft where the first pulley 42 is located is rotatably mounted on the base plate 1, while the other end thereof is rotatably mounted on the first mount 8, so as to ensure the stable rotation of the first pulley 42. The first mount 8 may be configured as a disk with a plurality of hollows, which both reduces its weight and maintains a small volume. Since the first pulley 42 is adjacent to the first gear set 31, in the present embodiment, the first mount 8 and the holding plate 6 are configured as a one-piece structure, both of which may be thermoformed of plastic, to facilitate their mounting.

One end of a rotation shaft where the second pulley 43 is located is rotatably mounted on the base plate 1, while the other end thereof is rotatably mounted on the second mount 9, so as to ensure the stable rotation of the second pulley 43. The second mount 9 can be locked and fixed on the base plate 1 via screws. In the present embodiment, the rotation shaft where the second pulley 43 is located is a sleeve formed on a hub of the second pulley 43, and the second mount 9 is arranged in parallel with the base plate 1. At the same time, a side of the second mount 9 away from the base plate 1 is recessed toward the base plate 1, the recess forms a circular groove, and a relative position sensor system 10 is mounted in the circular groove. The relative position sensor system 10 is configured for detecting relevant parameters of the rotation shaft where the second pulley 43 is located, and the relevant parameters include but are not limited to information about the speed and position of the rotation shaft where the second pulley 43 is located. By mounting the relative position sensor system 10 within the recessed groove, the structure is more compact, thereby reducing the bulk of the integrated power system.

With reference to FIG. 1, specifically, the torque output mechanism 5 includes an output shaft 51 and an output disc 52. The output shaft 51 is located on the side of the base plate 1 close to the second gear set 32, the output shaft 51 is coaxially arranged with the second pulley 43, the output shaft 51 is fixed with the rotation shaft where the second pulley 43 is located, and the both in the present embodiment are integrally formed. That is, the output shaft 51 rotates synchronously with the second pulley 43 at the same rotation speed. The output disc 52 is fixed at the end of the output shaft 51 and is located on the side of the base plate 1 close to the second gear set 32, making the integrated power system more compact. In the present embodiment, the output disc 52 and the output shaft 51 are also of an integral structure, namely, the output disc 52, the output shaft 51, the rotation shaft of the second pulley 43 and the second pulley 43 are of an integral structure, such a design not only facilitates mounting, but also ensures a stable output state.

Referring to FIGS. 1 and 4, the output disc 52 of the above-mentioned torque output mechanism 5 is coupled with an actuator 12, and particularly, when coupled with the output disc 52, the both can be coupled and fixed via a flange. The actuator 12, as a final actuation element of the integrated power system, performs synchronous rotation along with the output disc 52, and the movement state finally output may be an oscillation about an axis of the output disc 52. Of course, when the actuator 12 rotates once along with the output disc 52, the actuator 12 can also perform a rotation about the axis of the output disc 52, the specific movement state thereof can be set according to the actual usage requirements accordingly, and the setting thereof can be achieved by controlling the forward and reverse rotation of the drive motor 2.

In the present embodiment, the actuator 12, as a linkage, is configured to be coupled with the leg structure of fibula portion in the lower extremity exoskeleton system. As the output disc 52 rotates, the actuator 12 would be driven to rotate, thereby achieving the movement of the leg structure of fibula portion. For ease of understanding, the movement state of the leg structure of fibula portion is similar to the movement state of the lower leg relative to the knee joint when a person walks. It should be understood that this is merely an example of one application scenario in the integrated power system, not the only application of the integrated power system, and that the actuator 12 may be used in a variety of work environments where output states of oscillation or rotation are desired.

With reference to FIGS. 1 and 3, the base plate 1 serves as a base part of the whole integrated power system, and in order to stably mount the base plate 1, a fixing disc 13 is provided on a side of the base plate 1 close to the output disc 52. In the present embodiment, the fixing disc 13 is integrally formed with the base plate 1, and the fixing disc 13 is in the shape of a disc. Meanwhile, the fixing disc 13 is coaxially arranged with the output disc 52. A base body fastener 14 is fixedly mounted on a side of the fixing disc 13 remote from the base plate 1, and the base body fastener 14 can serve as a connection portion for fixing the integrated power system to a matrix to which it is applied. Through the base body fastener 14, the base plate 1 can be fixedly mounted.

Since the fixing disc 13 is arranged coaxially with the output disc 52, and the base body fastener 14 and the actuator 12 are designed as components respectively connected to the fixing disc 13 and the output disc 52, the actuator 12 can oscillate or rotate relative to the base body fastener 14 when the output disc 52 is driven to rotate by the drive motor 2.

In the present embodiment, the base body fastener 14 is a linkage that is configured to be coupled with the leg structure of femur portion in the lower extremity exoskeleton system, and in a particular application, is configured to be secured to a portion of the leg structure of femur portion in the lower extremity exoskeleton system located in the knee joint. In connection with the embodiment described above where the actuator 12 is coupled with the leg structure of fibula portion in the lower extremity exoskeleton system, when the base body fastener 14 is secured to the leg structure of femur portion in the lower extremity exoskeleton system, the actuator 12 may cause the leg structure of fibula portion in the lower extremity exoskeleton system to swing a certain amount as the output disc 52 rotates. When the integrated power system is applied in the lower extremity exoskeleton system, it can be used as the leg structure where the knee joint connects the fibula portion and the femur portion respectively, so as to realize the walking action of the lower extremity exoskeleton. It should also be understood that this is merely an example of one application scenario of the integrated power system, not the only application of the integrated power system.

Further, a limit disc 141 is provided on a side of the base body fastener 14 remote from the fixing disc 13, the limit disc 141 is in the shape of a disc, and the limit disc 141 is coaxially arranged with the fixing disc 13 and the diameters of the both are equal. Likewise, the limit disc 141 is fixedly connected to the base body fastener 14 in a flange connection, that is to say, the limit disc 141 and the base plate 1 are always kept in a relatively fixed state.

The first circumferential limit block 142 is mounted on a side of the limit disc 141 away from the base body fastener 14, the first circumferential limit block 142 may be fixed on the limit disc 141 through screws. The second circumferential limit block 143 is mounted on a side of the actuator 12 close to the output disc 52, and the second circumferential limit block 143 may be fixed on the actuator 12 through screws. When the actuator 12 is mounted on the output disc 52, the first circumferential limit block 142 and the second circumferential limit block 143 partially overlap each other in an axial direction of the output disc 52. That is, when the drive motor 2 drives the actuator 12 to rotate, the rotation angle of the actuator 12 can be limited due to the cooperation of the first circumferential limit block 142 and the second circumferential limit block 143. When the integrated power system is applied as a knee joint to the lower extremity exoskeleton system, the rotation angle thereof is the rotation angle of the leg structure of fibula portion in the lower extremity exoskeleton system relative to the leg structure of femur portion in the lower extremity exoskeleton system, and the first circumferential limit block 142 and the second circumferential limit block 143 are used to define a maximum rotation angle of the leg structure of fibula portion and the leg structure of femur portion in the lower extremity exoskeleton system. Optionally, the maximum rotation angle between the actuator 12 and the base body fastener 14 is 135 degrees.

Specifically, a servo motor is selected as the drive motor 2, and a housing of the drive motor 2 is fixed to a side of the base plate 1 close to the second gear set 32 via bolts. Meanwhile, the output shaft of the drive motor 2 passes through the base plate 1 and protrudes out of the side of the base plate 1 close to the first gear set 31, and the protruding portion of the output shaft of the drive motor 2 and the power gear 311 in the first gear set 31 are assembled in cooperation with each other. By this design, the space occupied by the drive motor 2 can be reduced to some extent, making the overall integrated power system smaller. Further, the drive motor 2 is provided with an absolute position sensor system 11 for detecting relevant parameters of the output shaft of the drive motor 2, including but not limited to information about the speed, the position and so on of the drive motor 2.

At the same time, the two sides of the base plate 1 are further provided with the first protective housing 16 and the second protective housing 17, respectively. The first protective housing 16 covers outer sides of the drive motor 2 and the second gear set 32, while the second protective housing 17 covers outer sides of the first gear set 31 and the synchronous belt mechanism for power transmission 4, so as to protect the integrated power system.

The embodiment of the present disclosure also discloses an exoskeleton robot, including the above-mentioned integrated power system based on toothed belt structure, and further including a back structure of main body 18, a leg structure of femur portion 19 and a leg structure of fibula portion 20, and in particular, the leg structure of femur portion 19 is hinged with a waist portion of the back structure of main body 18, and the other end of the leg structure of femur portion 19 is connected to the leg structure of fibula portion 20 via the above-mentioned integrated power system based on toothed belt structure. Specifically when being connected, the leg structure of femur portion 19 may be coupled with the base body fastener 14, in order to fix the integrated power system as a whole, while the leg structure of fibula portion 20 is coupled with the actuator 12, so as to realize the relative rotation of the leg structure of fibula portion 20 and the leg structure of femur portion 19.

Further, the back structure of main body 18 is provided with a shoulder strap 21, which may be in a snap connection with the back structure of main body 18. In specific applications, the back structure of main body 18 is worn over an upper body of a human body and held stationary by the shoulder strap 21. A side of the leg structure of fibula portion 20 remote from the leg structure of femur portion 19 is provided with a shoe cover 22 to be worn by a person, and the shoe cover 22 is also rotatably connected to the leg structure of fibula portion 20.

The implementation principle of the embodiments of the present disclosure is as follows.

When the exoskeleton robot is worn, the leg structure of fibula portion 20, driven by the integrated power system, may rotate relative to the leg structure of femur portion 19 when people walks, so as to assist people to walk.

In particular, when the integrated power system is in operation, the drive motor 2 drives the power gear 311 to rotate, the first-stage reduction is preformed via the first gear set 31, then the power is transmitted to the second gear set 32 to perform the second-stage reduction, then the third-stage reduction is performed via the synchronous belt mechanism for power transmission 4, and finally the power is output via the torque output mechanism 5, thereby driving the leg structure of fibula portion 20 to move.

The embodiments in the section of detailed embodiments are preferred embodiments of the present disclosure, and do not define the scope of protection of the present disclosure thereby, wherein like parts are indicated by like numerals. Therefore, any equivalent changes made according to the structure, shape and principle of the present disclosure are to be embraced within the protection scope of the present disclosure.

### LIST OF REFERENCE SIGNS

1 base plate

2 drive motor

3 reduction gear mechanism

31 first gear set

311 drive gear

312 first reduction gear

32 second gear set

321 intermediate gear

322 second reduction gear

4 synchronous belt mechanism for power transmission

41 synchronous belt

42 first pulley

43 second pulley

5 torque output mechanism

51 output shaft

52 output disc

6 holding plate

7 mounting rack

71 PCB board

8 first mount

9 second mount

10 relative position sensor system

11 absolute position sensor system

12 actuator

13 fixing disc

14 base body fastener

141 limit disc

142 first circumferential limit block

143 second circumferential limit block

16 first protective housing

17 second protective housing

18 back structure of main body

19 leg structure of femur portion

20 leg structure of fibula portion

21 shoulder strap

22 shoe cover

What is claimed is:

1. An integrated power system based on toothed belt structure, comprising a base plate, and a drive motor, a reduction gear mechanism, a synchronous belt mechanism for power transmission and a torque output mechanism sequentially arranged on the base plate for power transmission, wherein the reduction gear mechanism comprises a first gear set and a second gear set configured to reduce an output rotation speed of the drive motor, the first gear set and the second gear set are respectively located on two sides of the base plate, the drive motor and the second gear set are located on a first side of the two sides of the base plate, the synchronous belt mechanism for power transmission and the first gear set are located on a second side of the two sides of the base plate, and the torque output mechanism is located on the first side of the two sides of the base plate.

2. The integrated power system based on toothed belt structure according to claim 1, wherein the first gear set comprises a power gear and a first reduction gear meshed with each other, the power gear is fixedly mounted on an output shaft of the drive motor, the first reduction gear is located on the second side of the two sides of the base plate and rotatably mounted on the base plate, and a diameter of the first reduction gear is greater than a diameter of the power gear.

3. The integrated power system based on toothed belt structure according to claim 2, wherein a holding plate is mounted on the second side of the two sides of the base plate, the holding plate is in a shape of a plate with a plurality of hollows, and a gear shaft on the first reduction gear is rotatably mounted on the base plate at a first end of the gear shaft and rotatably mounted on the holding plate at a second end of the gear shaft.

4. The integrated power system based on toothed belt structure according to claim 2, wherein the second gear set comprises an intermediate gear and a second reduction gear meshed with each other, the intermediate gear and the second reduction gear both are rotatably mounted on the base plate, the intermediate gear and the first reduction gear are coaxially arranged and rotate synchronously, a diameter of the second reduction gear is greater than a diameter of the intermediate gear, and the diameter of the intermediate gear is smaller than the diameter of the first reduction gear.

5. The integrated power system based on toothed belt structure according to claim 2, wherein the synchronous belt mechanism for power transmission comprises a synchronous belt, and a first pulley and a second pulley rotatably mounted on the base plate, the first pulley and the second pulley are arranged on the second side of the two sides of the base plate, the synchronous belt is wound around the first pulley and the second pulley, the first pulley is coaxially arranged with a second reduction gear in a second gear set, and a diameter of the second pulley is greater than a diameter of the first pulley.

6. The integrated power system based on toothed belt structure according to claim 5, wherein a first mount and a second mount are respectively provided on the second side of the two sides of the base plate, a first end of a rotation shaft where the first pulley is located is rotatably mounted on the base plate while a second end of the rotation shaft where the first pulley is located is rotatably mounted on the first mount, and a first end of a rotation shaft where the second pulley is located is rotatably mounted on the base plate while a second end of the rotation shaft where the second pulley is located is rotatably mounted on the second mount.

7. The integrated power system based on toothed belt structure according to claim 6, wherein the torque output mechanism comprises an output shaft and an output disc, the output shaft of the torque output mechanism is located on the first side of the two sides of the base plate, coaxially arranged with the second pulley and fixed with the rotation shaft where the second pulley is located, and the output disc is fixed at an end of the output shaft of the torque output mechanism and located on the first side of the two sides of the base plate.

8. The integrated power system based on toothed belt structure according to claim 7, wherein an actuator is fixedly connected to the output disc, a fixing disc is provided on the first side of the two sides of the base plate, the fixing disc is coaxially arranged with the output disc, and a base body fastener is fixedly mounted on a side of the fixing disc away from the base plate.

9. The integrated power system based on toothed belt structure according to claim 8, wherein a limit disc is fixedly arranged on a side of the base body fastener away from the fixing disc, the limit disc is coaxially arranged with the fixing disc, a first circumferential limit block is mounted on a side of the limit disc away from the base body fastener, a second circumferential limit block is mounted on a side of the actuator close to the output disc, and the first circumferential limit block and the second circumferential limit block partially overlap each other in an axial direction of the output disc.

10. An exoskeleton robot, comprising the integrated power system based on toothed belt structure according to claim 1, further comprising a back structure of main body, a leg structure of femur portion hinged with a waist portion of the back structure of main body, and a leg structure of fibula portion coupled with a base body fastener, wherein the leg structure of fibula portion is coupled with an actuator.
